(19) United States
(12) Patent Application Publication
(10) Pub. No.: US 2007/0126912 A1
(43) Pub. Date: Jun. 7, 2007

(54) Camera module and manufacturing method for such a camera module

(75) Inventors: Leendert De Bruin, Eindhoven (NL); Arjen Gerben Van Der Sijde, Eindhoven (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 10/577,295

(22) PCT Filed: Oct. 19, 2004
(86) PCT No.: PCT/IB04/52140

§ 371 Date: Apr. 26, 2006

(30) Foreign Application Priority Data
Oct. 27, 2003 (EP) 03103980.3

(51) Int. Cl. H04N 5/225

(52) U.S. Cl. 348/340

(57) ABSTRACT

The invention relates to a camera module (10) which comprises a semiconductor housing (1) that contains a solid-state image sensor (2) with a radiation-sensitive surface area (3), and an optical element (4) located above the solid-state sensor (2) and which forms a shield against laterally scattered radiation, comprising a disk-shaped body with a primary radiation-opaque area and a secondary radiation-transparent area located within the primary area, of which a surface close to the sensor (2) is smaller than a surface more remote from the sensor (2). According to the invention the optical element (4) comprises at least one plate (4) of transparent material of which two sides are covered with a radiation-opaque layer (41,42) which is provided with an aperture, in which the aperture in the layer (41) close to the sensor (2) has a smaller surface than the aperture in the layer (42) located remote from the sensor (2), and in which the primary and secondary areas are defined respectively by portions of the at least one plate (40) sandwiched between the opaque layers (41,42) and the apertures therein. Such a module (10) is particularly well-suited to wafer-scale manufacturing. The invention also comprises a method for manufacturing such a module (10).

The invention relates to a camera module which comprises a housing that contains a solid-state image sensor with a radiation-sensitive surface, and an optical element located above the solid-state sensor and which forms a shield against laterally scattered radiation to protect the radiation-sensitive surface and comprises a disk-shaped body with a primary radiation-opaque area and a secondary radiation-transparent area located within the primary area, which secondary area is located above the radiation-sensitive surface of the sensor and of which a surface close to the sensor is smaller than a surface remote from the sensor. The invention also relates to a method for the manufacturing of a similar module.

Such a module is disclosed in U.S. Pat. No. 4,561,015 published on 24 Dec. 1985. A known camera module is described therein which comprises a housing which contains a solid-state image sensor. The housing contains a matrix (or array) of such sensors. An optical element disposed above the array of sensors, has the form of a disk-shaped body of opaque material in which a matrix of funnel-shaped recesses is formed, which are aligned with the radiation-sensitive surface of the sensor, whereby said element forms a shield against the laterally scattered radiation, in particular scattered light. The disk-shaped body comprises lenses—in the bottom of the funnels—for the appropriate focusing of the incident radiation on the radiation-sensitive surface of the image sensor. The matrix of the known module serves to eliminate the consequences of a defective pixel since there is a good chance that the corresponding pixel of one or more of the sensors will not be defective.

A drawback of the known module is that it is not easy to manufacture. Moreover, the shield against scattered radiation is not sufficiently compact and the design of the funnel-shaped recesses makes adjustment not easy.

It is an object of the present invention to provide a module of the kind referred to in the preamble which overcomes these disadvantages and which can be manufactured easily and which is provided with a readily adjustable and compact shield against scattered radiation.

For this purpose, a module of the kind referred to in the preamble according to the invention is characterized in that the optical element comprises at least one plate of transparent material two sides of which are covered with a layer of radiation-opaque material, in which plate an aperture is defined in which the aperture in the layer deposited on a side of the at least one plate close to the sensor has a smaller surface area than the aperture in the layer on a side of the at least one plate remote from the sensor and in which the primary and secondary areas are defined by portions of the transparent plate sandwiched between the opaque layers and the apertures therein, respectively. The use of said optical element makes possible its manufacture with the aid of techniques such as deposition, photolithography and etching. Since these are conventionally used techniques in IC (=Integrated Circuit) technology, the manufacturing of the camera module is fully compatible with this technology. It facilitates a so-called “wafer-scale” manufacturing process, which produces a cost-effective and compact module. This is particularly important if, according to the object of the invention, individual camera modules are manufactured with a single image sensor by means of a separation technique such as dicing which is common in IC technology. Said modules are particularly well-suited for applications in hand-held devices such as mobile phones and personal digital assistant modules, where the compactness of the module is of paramount importance. Furthermore, the shape of the (truncated) conical part of the transparent plate can be easily adjusted depending on the thickness of the plate and the diameters of the apertures in the radiation-opaque layers deposited thereon. Therefore, the adjustment of the shape of the conical part not only offers protection against scattered radiation, but also permits the simple adjustment of the angle of the field of view of the module. An additional important advantage of a module according to the invention is that at least one plate can also serve as a (hermetic) seal of the module, in particular when the module is made of glass. The plate also offers protection against dust on another component such as a lens, which may be positioned between the plate and the sensor. For this purpose, the known device requires an additional plate, which is disposed on the array of funnel-shaped recesses.

In a preferred embodiment of a camera module according to the invention, the optical element comprises a single transparent plate, of which the upper and lower surfaces are covered with a radiation-opaque layer with circular apertures. Said module pre-eminently offers the advantages described above.

Another advantageous embodiment is characterized in that the optical element comprises two or more transparent plates, which are separated from each other and have at least one side covered with a radiation-opaque layer provided with an aperture and the circumferences of the apertures are located so as to form a cone. Thus, the height of the conical, radiation-sensitive area of the shield against scattered radiation can be easily adjusted without a proportionate increase in the weight of the optical element.

Furthermore, the operation can be optimized such that an optical element comprising three transparent plates for instance, may comprise six opaque plates, the apertures of which are located substantially at equal distances on the perimeter of the conical area.

Preferably, the transparent material of the optical elements should be synthetic or a glass. The module is therefore more cost-effective and the radiation transparency of the conical area of the shield against scattered light can approach the transparency of an air-filled space. The layer of the opaque material is preferably made of blackened metal. Such a layer is highly compatible with IC technology and reflects hardly any radiation.

In an attractive variant of a module according to the invention, the housing contains a lens aligned with the image sensor, which lens is formed in an additional transparent plate. As a result, such a lens can be manufactured using a wafer-scale manufacturing process. The plate then protects the lens against dust etc.

A method for the manufacturing of a camera module, which module comprises a housing that contains a solid-state image sensor with a radiation-sensitive surface, and an optical element located above the solid-state sensor and which forms a protective shield against laterally scattered radiation to protect the radiation-sensitive surface and comprises a disk-shaped body with a primary radiation-opaque area and a secondary radiation-transparent area located within the primary area, which secondary area is located above the radiation-sensitive surface of the sensor and of which a surface close to the sensor is smaller than a surface located remote from the sensor, and which, according to the invention, is characterized in that the optical element is defined by at least one plate of transparent material in the housing above the sensor, of which two sides are covered with a radiation-opaque layer which are provided with an aperture, in which the aperture in the layer on a side of the plate close to the sensor has a smaller surface than the aperture in the layer on a side of the at least one plate remote from the sensor, and in which the primary and secondary areas are defined by portions of the transparent plate which are sandwiched between the opaque layers and the apertures therein, respectively. Using the method described, it is possible to manufacture camera modules according to the invention in a simple manner.

Preferably, a plurality of optical elements and, if required, a plurality of further optical components such as a lens are formed in a first stack of disk-shaped bodies, and a plurality of solid-state image sensors are formed in a second stack of disk-shaped bodies, in which the electrical connections of the solid-state image sensors extend to the lower side of the second stack and part of the first stack is deposited on each image sensor, after which individual camera modules are obtained by separating the second stack of image sensors by means of a dicing operation. Such a method is particularly well-suited for wafer-scale manufacturing.

In a first variant of the method according to the invention, the second stack is separated into individual elements each with its own image sensor by means of a first dicing operation, which elements are deposited on the first stack of optical elements using a so-called pick-and-place machine prior to the separation of the first stack by means of a second dicing operation. Therefore, two parallel wafer-scale processes are used. The advantage of this embodiment, where the individual elements of the second stack are deposited on the first stack, is that the alignment is less critical as each part of the second stack is aligned separately with the first stack and the positioning accuracy of the pick-and-place machines used in the semiconductor industry is more than adequate for this purpose. However, on the whole the manufacturing method is a wafer-scale manufacturing process. An important additional advantage of this method is that the module contains only elements with an image sensor which have been tested so that there is an increase in manufacturing yield.

In a further variant, the first stack is deposited on and aligned with the second stack and the optical elements (and components) and the image sensors are separated via a single dicing operation.

Preferably, the second stack is deposited on a film during the dicing operation and after dicing up to the film, the grooves between the individual image sensors formed by this operation and the grooves—either formed by dicing or otherwise—which are located between individual optical components, are filled with an electrically insulating synthetic material, which is diced with the aid of a dicing saw with a smaller saw cut and the individual camera modules provided with an electrically insulating shell are subsequently removed from the film.

These and other aspects of the invention are apparent from and will be elucidated with reference to the embodiment(s) described hereinafter.

In the drawings:

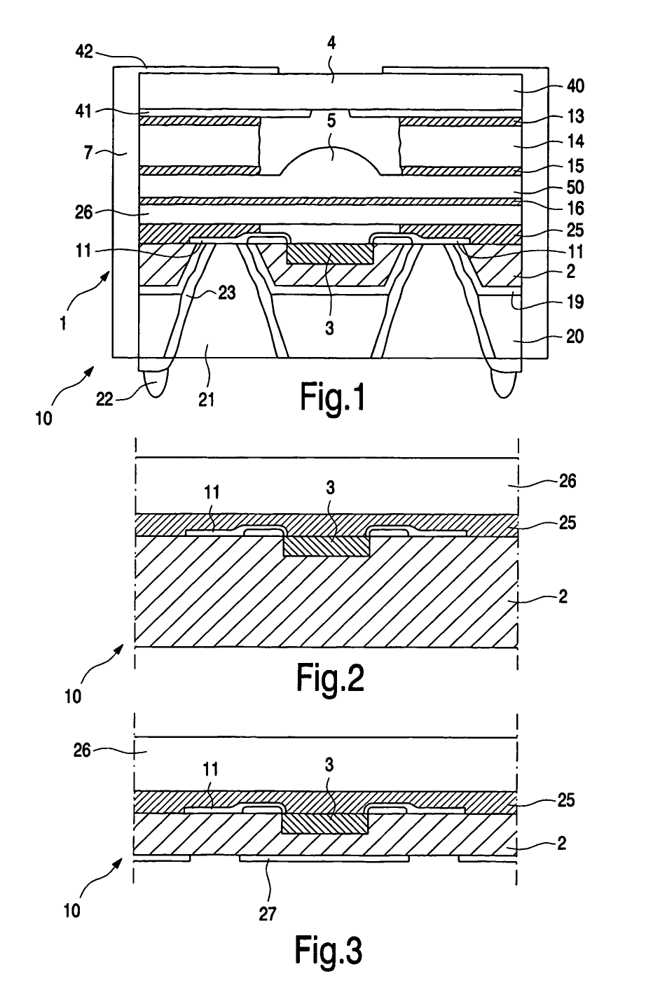

FIG. 1 shows a schematic and cross-sectional view perpendicular to the thickness direction of an embodiment of a camera module according to the invention, and

FIGS. 2 to 10 shows the consecutive stages of the manufacturing method of an embodiment of the camera module illustrated in FIG. 1 according to the invention.

The Figures are not drawn to scale and certain dimensions, such as the dimensions in the thickness direction, are shown out of proportion for the sake of clarity. Corresponding areas or parts are, where possible, indicated in the various Figures by the same reference numeral and the same shading.

FIG. 1 shows a schematic and cross-sectional view perpendicular to the thickness direction of an embodiment of a camera module according to the invention. The module 10 comprises a housing 1 with a synthetic shell 7 which is electrically insulating and comprises an opaque epoxy. The module 10 comprises an opto-electronic semiconductor element, in the present case a CMOS (=Complementary Metal Oxide Semiconductor) solid-state image sensor 2 for cameras with a semiconductor body, that has an optically active region 3 on one surface and a non-optically active region within which the electrical connection areas 11 of the sensor 2 are located. An optical element 4 is located above the optically active region 3 of the surface of the semiconductor body. Moreover, so-called micro lenses are located on the surface of the CMOS sensor and each pixel thereof. These are not represented in the drawing.

According to the invention, the optical element 4 comprises a transparent plate 40, in the present case made of glass, of which the lateral surfaces are covered with opaque layers 41,42 made of a blackened metal—such as chrome—in the present case. Two concentric, circular apertures above the active region 3 of the sensor 2 are defined in these surfaces, where the diameter of the lower aperture is smaller than the diameter of the upper aperture. In this embodiment, the diameter of the apertures is 2 mm and 3 mm respectively, whereas the thickness of the plate 40 lies between 1 and 2 mm. Therefore, the truncated cone may be given an apex of approximately 72 degrees. Element 4 therefore not only forms a particularly adequate shield against laterally scattered radiation, i.e. scattered light, to protect the active region 3 of the sensor 2, but also seals the housing 1 against dust and the ambient atmosphere. Furthermore, the field of view of the module is restricted to a desired angle of approximately 70 degrees.

The transparent plate 40 is mounted by means of the bonding layer 13 on a spacer 14 which is mounted by means of a further bonding layer 15 on a lens plate 50, of which the center contains a lens 5. By means of a transparent bonding layer 16 the lens plate 50 is mounted on a transparent substrate 26 which is mounted on the image sensor 2 by means of a further transparent bonding layer 25. The sensor 2 is mounted on a further glass plate 20 by means of an epoxy layer 19. In said glass plate 20, grooves 21 are formed which extend across the sensor 2 to the connection areas 11. On the lower side of said glass plate 20, connection conductors, in the form of so-called solder bumps 22, are applied which are connected with the connection areas 11 by means of conductor tracks 23 on a wall of the grooves 21 and which, for instance, allow module 10 to be mounted on a PCB (=Printed Circuit Board)—not illustrated in the drawing. The module 10 can be manufactured as follows using the method according to the invention.

FIGS. 2 to 10 show the camera module illustrated in FIG. 1 in the subsequent stages of the manufacturing method of an embodiment according to the invention. The sensor 2 (see FIG. 2) is manufactured in the conventional manner with the aid of IC technology and comprises a relatively thick silicon substrate which is not represented separately in the drawing. The sensor 2 is then mounted on a transparent substrate 26, in the present case glass, by means of a transparent bonding layer 25.

Subsequently, a substantial portion (see FIG. 3) of the silicon substrate is removed by means of etching and polishing. Hereafter, a mask layer 27, in this case a photo mask, is arranged in a pattern whereby the apertures in the mask layer 27 are located underneath the connection areas 11.

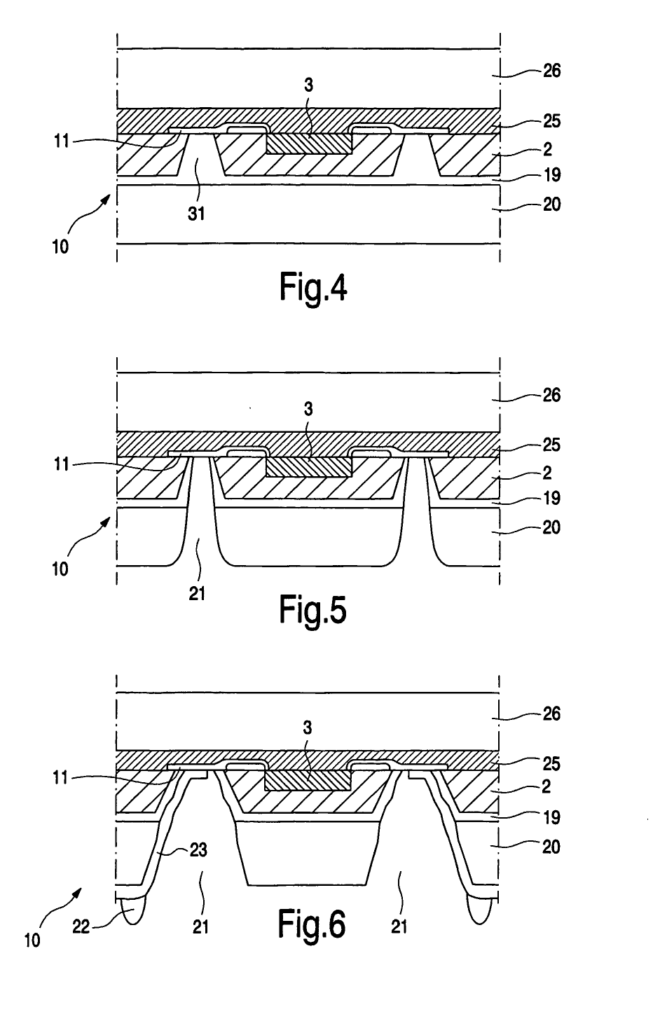

Subsequently, (see FIG. 4) grooves 31 which extend to a layer of silicon dioxide—not represented in the drawing—located underneath the connection areas 11 are formed in the sensor 2 by means of etching. This layer is removed during a separate etching process. After the removal of the mask layer 27, an epoxy layer 19 is deposited and used to mount a glass plate 20 on the sensor 2 and to fill the grooves 31 in the sensor.

Subsequently, by means of a dicing operation (see FIG. 5) the grooves 21 are formed in the glass plate 20, which grooves extend into the connection areas 11. The width of these grooves 21 is smaller than the width of the grooves 31 filled with the epoxy layer 19 so that the walls of the grooves 31 remain covered with the electrically insulating epoxy layer 19.

Subsequently, (see FIG. 6) the connection conductors 23 are mounted in the grooves 21 which are connected with the connection areas 11. So-called solder bumps 22 are applied to the lower side of the module 10 for the final (electrical) assembly of the module 10.

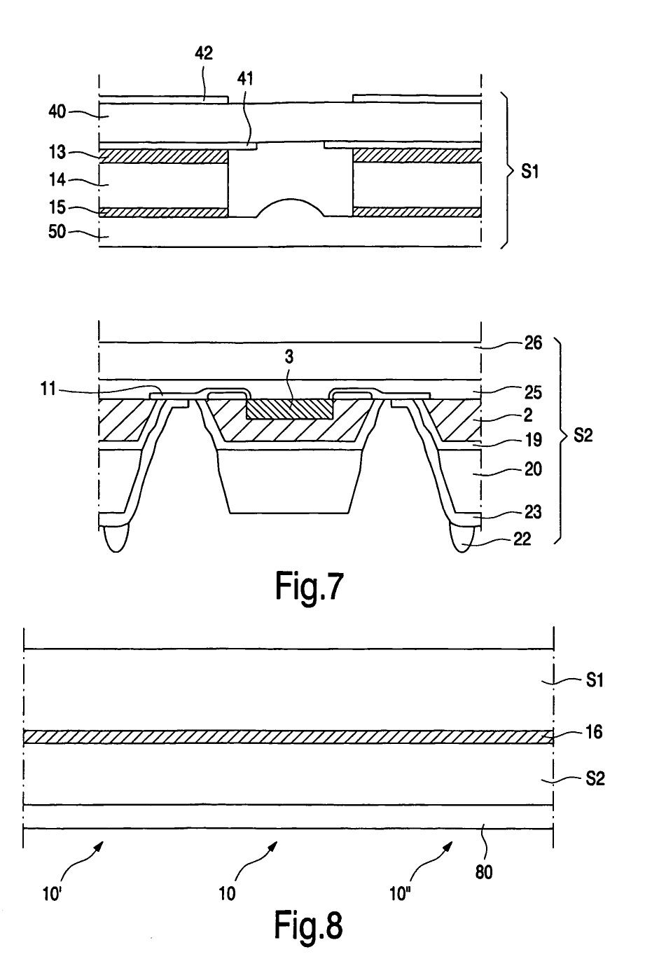

Prior to the subsequent assembly stage (see FIG. 7) of the module 10, the result of a separate partial assembly is discussed. In FIG. 7, the result is presented in the form of a first stack S1 of the assembly of the upper part of the module 10 illustrated in FIG. 1. Said stack S1 is obtained by alignment and subsequently bonding of the parts 40, 14 and 50 by means of the bonding layers 13, 15 deposited thereon. The module 10 itself is presented in FIG. 7 as a second stack S2. The first stack S1 is now aligned with the sensor 2 and bonded to the second stack S2 of the module 10 by means of the transparent bonding layer 16 which is, for instance, deposited on the lower side of area 50 or on the upper side of the substrate 26.

The result thereof is shown in a schematic view in FIG. 8, in which three modules 10, 10′, 10″ are represented of the plurality of modules 10 which are assembled simultaneously in the wafer-scale process described and of which thus far only one module has been represented in the Figures. The mounted stacks S1, S2 are then bonded to a rubber film 80 by means of a bonding layer, which is not shown in the drawing.

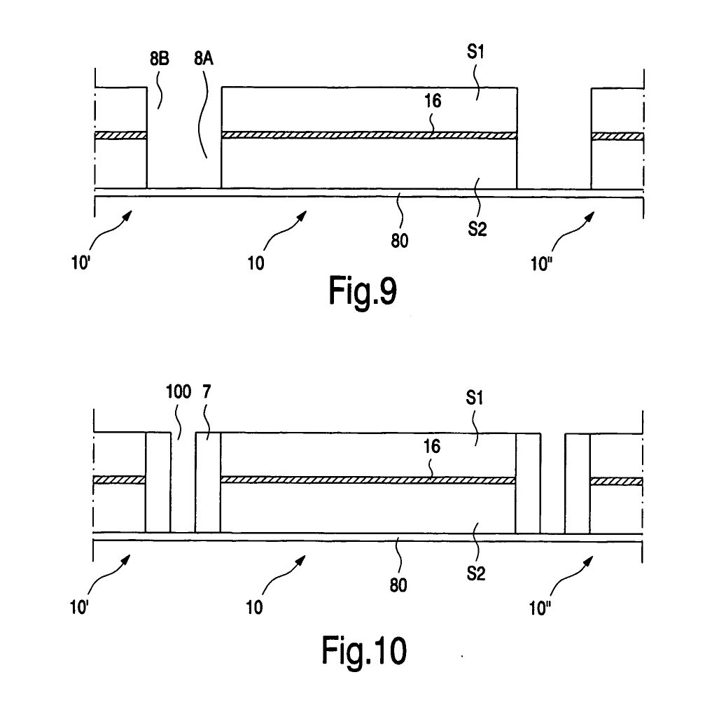

Subsequently, (see FIG. 9) grooves 8A, 8B are formed using the dicing operation, between respectively parts of the second stack S2 and parts of the first stack S1. The grooves 8A, 8B are defined in two mutually perpendicular directions.

Subsequently, (see FIG. 10) the grooves are filled with an opaque epoxy synthetic material 7, and the grooves 100 are formed in the synthetic material 7 by means of a further dicing operation and extend to the film 80. Individual modules 10, 10′, 10″ as illustrated in FIG. 1 can now be removed from the film 80 and are ready for use.

In a variant of the method of manufacturing of the module 10 described above, the illustration in FIG. 2 already assumes the first stack S1 presented in FIG. 7. Said stack then performs the function of the substrate 26 illustrated in FIG. 2, which function thus becomes superfluous. The stack S1 is directly bonded by means of the bonding layer 16 to the first part of stack S2 in the shape of the sensor 2 as it emerges from IC production. The manufacturing process then follows the method represented in FIGS. 3 to 6 and described above, and reaches the stage shown in FIG. 8 and subsequently the method is continued as shown in FIGS. 8 to 10 and as described above.

In a further variant of the method of manufacturing described above of the module 10 according to the invention, a change takes place in the stage represented in FIG. 7. Instead of bonding the first stack S1 to the second stack S, the second stack S2 is bonded to a rubber film and diced into sections whereby each section can be used in a single module 10. With the aid of a so-called pick-and-place machine, the individual sections of the second stack S2 are then removed from the rubber film, dipped in the bonding agent and—after alignment—bonded to the first stack S1, each at the location of a single module 10. In the stage shown in FIG. 9, the grooves 8A of the second stack S2 have already been formed for the dicing operation and only the grooves 8B are formed in the first stack S1 during the dicing operation in order to manufacture the individual modules 10. The assembly can then continue as described in FIG. 10 and as described during the discussion of the first example. It should be noted that the film 80 shown in FIGS. 9 and 10 is adjacent to the first stack S1 which is deposited thereon with its upper surface.

The invention is not limited to the exemplary embodiment described since for those skilled in the art many embodiments may be realized without departing from the spirit and scope of the invention. Modules with a different geometry and/or different dimensions can also be manufactured. Instead of a semi-convex lens, a concave lens may also be chosen as the optical component. Numerous variations are possible within the scope of the method of manufacturing. The aforementioned remark with regard to the module also applies to the manufacturing thereof. Instead of dicing, it is possible to manufacture the individual modules with the aid of a laser beam. Manufacturing modules with the aid of etching is also conceivable.

Furthermore it should be noted that the module may contain additional active and passive semiconductor elements or electronic components such as diodes and/or transistors and resistors and/or capacitors, either in the shape of an integrated circuit or otherwise. These can be used to generate additional advantageous circuits which fulfill functions such as timer, pulse generator, DA (=Digital to Analog) converter or image processor by means of DSP (=Digital Signal Processing). Furthermore, the plate can be provided with possible further functions. An anti-reflection layer can be deposited on the plate as well as a layer whose transparent property may be chosen or adjusted—either electrically or otherwise.

It should be emphasized that the structure of the module above the sensor may comprise more or fewer and also different optical components. The sequence of the parts may also be modified without departing from the scope of the invention. Such modifications may relate to the cost price and also to the specifications required for certain applications.

1. A camera module comprising
a housing containing a solid-state image sensor with a radiation-sensitive surface, and an optical element located above the solid-state image sensor and the housing forming a shield against laterally scattered radiation to protect the radiation-sensitive surface; and
the housing includes a disk-shaped body with a primary radiation-opaque area and a secondary radiation-transparent area located within the primary area, the secondary area is located above the radiation-sensitive surface of the sensor and wherein a surface close to the sensor is smaller than a surface remote from the sensor; and
the optical element includes at least one plate of transparent material having two sides, each side covered with a layer of radiation-opaque material (ROM), and an aperture is defined in the at least one plate; and
wherein the aperture in the ROM layer deposited on a side of the at least one plate close to the sensor has a smaller surface area than the aperture in the ROM layer on a side of the at least one plate remote from the sensor and
wherein the primary radiation-opaque and secondary radiation-transparent areas are defined by portions of the plate of transparent material sandwiched between the radiation opaque layers and the apertures therein, respectively.

2. A camera module as claimed in claim 1, characterized in that the optical element includes a single transparent plate whose upper and lower surfaces are both covered with a radiation-opaque layer in which circular and concentric apertures are provided.

3. A camera module as claimed in claim 1, characterized in that the optical element includes two or more transparent plates which are separated from each other and of which at least one side is covered with a radiation-opaque layer in which an aperture has been defined and whereby the circumferences of the apertures are substantially located on a cone.

4. A camera module as claimed in claim 1, characterized in that the transparent material includes a glass or a synthetic material.

5. A camera module as claimed in claim 1, characterized in that the opaque layer is made of blackened metal.

6. A camera module as claimed in claim 1, characterized in that the housing further comprises an optical component in the form of a lens which is also located above the radiation-sensitive surface of the sensor and which is formed in a further transparent plate.

7. A mobile telephone or personal digital assistant provided with a camera module as claimed in claim 1.

8. A method for manufacturing a camera module, the camera module comprising
a housing containing a solid-state image sensor with a radiation-sensitive surface, and an optical element located above the solid-state image sensor and the housing forming a shield against laterally scattered radiation to protect the radiation-sensitive surface; and
the housing includes a disk-shaped body with a primary radiation-opaque area and a secondary radiation-transparent area located within the primary area, the secondary area is located above the radiation-sensitive surface of the sensor and wherein a surface close to the sensor is smaller than a surface remote from the sensor; and
the optical element includes at least one plate of transparent material having two sides, each side covered with a layer of radiation-opaque material (ROM), and an aperture is defined in the at least one plate; and
wherein the aperture in the ROM layer deposited on a side of the at least one plate close to the sensor has a smaller surface area than the aperture in the ROM layer on a side of the at least one plate remote from the sensor and
wherein the primary radiation-opaque and secondary radiation-transparent areas are defined by portions of the plate of transparent material sandwiched between the radiation opaque layers and the apertures therein, respectively.

9. A method as claimed in claim 8, characterized in that there is a plurality of optical elements and, if required.
a plurality of further components such as a lens are formed in a first stack of disk-shaped bodies, and
a plurality of solid-state image sensors are formed in a second stack of disk-shaped bodies, in which the electrical connections of the solid-state image sensors extend to the lower side of the second stack and
part of the first stack is deposited on each image sensor, after which individual camera modules are obtained by separating the second stack of image sensors by means of a dicing operation.

10. A method as claimed in claim 9, characterized in that the second stack is separated into individual elements each with its own image sensor by means of a first dicing operation, said elements are deposited on the first stack using a pick-and-place machine prior to the separation of the first stack by means of a second dicing operation.

11. A method as claimed in claim 9, characterized in that the first stack is aligned with and mounted on the second stack and the optical elements, any additional optical components and the image sensors, are separated via a single dicing operation.

12. A method as claimed in claim 9, characterized in that the second stack is deposited on a film during the dicing operation and, after dicing up to the film, the grooves between the individual image sensors formed by this operation and the grooves that are defined, the grooves located between individual optical elements and any further optical components are filled with an electrically insulating synthetic material, after which this synthetic material is diced with a dicing saw having a smaller saw cut and the individual camera modules covered with an electrically insulating shell are removed from the film.
